(19) United States
(12) Patent Application Publication
(10) Pub. No.: US 2015/0310570 A1
(43) Pub. Date: Oct. 29, 2015

(54) OPEN PRICING AND PRICING RULES

(71) Applicant: Duetto Research, Inc., San Francisco, CA (US)

(72) Inventors: Marco Benvenuti, Las Vegas, NV (US); Craig Weissman, San Francisco, CA (US); Patrick Bosworth, Las Vegas, NV (US); Neelav Rana, San Francisco, CA (US); Michael Skinner, San Francisco, CA (US); Jayesh Sureshchandra, San Francisco, CA (US); Anuj Jenveja, Las Vegas, NV (US); David Su, Hayward, CA (US)

(73) Assignee: Duetto Research, Inc., San Francisco, CA (US)

(21) Appl. No.: 14/263,239

(22) Filed: Apr. 28, 2014

(51) Int. Cl. G06Q 50/14; G06Q 30/02

(52) U.S. Cl. CPC G06Q 50/14; G06Q 30/0283; G06Q 30/0206

(57) ABSTRACT

A pricing rules engine identifies a plurality of potential competitors for a travel property and identifies one or more rule conditions. The pricing rules engine performs a pricing correlation on the plurality of potential competitors according to the one or more rule conditions and determines, based on a result of the pricing correlation, at least one of the plurality of potential competitors to be included in a competitor set. When an offer price exceeds a rule threshold, the pricing rules engine adjusts a sub-rate price discount for the travel property according to rates charged by competitor travel properties in the competitor set. When the capacity for a given room type satisfies the rule threshold, the pricing rules engine adjusts a price modifier for the given room type according to rates charged by competitor travel properties in the competitor set.

### TECHNICAL FIELD

This disclosure relates to the field of data analytics, and in particular to open pricing and pricing rules for travel properties.

### BACKGROUND OF THE INVENTION

The travel and hospitality industry in the United States and throughout the world is an ever increasing business sector. Advances in Internet and computing technology have significantly increased the opportunities to capture data from both travelers and travel properties (e.g., hotels, motels, bed and breakfasts, condominiums, houses). For example, web site based systems are used to offer the sale and rental of many travel properties and are used to make a large percentage of travel bookings. During these bookings, a significant amount of user travel data is received. The travel data may include, for example, a destination city, specific properties, dates of arrival, length of stay, room type, property amenities, price quotes, availability information, and/or other travel information. Property owners and managers are looking for chances to use this travel data to improve decisions relating to the management and sale of units in their travel properties. The mere availability of this data, however, does not by itself improve decisions that may lead to increased profits for the travel property. Conventional revenue management systems and booking engines are not equipped to make sufficient use of the newly acquired user travel data to deliver actionable insights and analysis as needed.

### BRIEF DESCRIPTION OF THE DRAWINGS

The present invention will be understood more fully from the detailed description given below and from the accompanying drawings of various embodiments of the present invention, which, however, should not be taken to limit the present invention to the specific embodiments, but are for explanation and understanding only.

FIG. 1 is a block diagram illustrating a cloud computing environment for a multi-tenant cloud architecture, according to an embodiment.

FIG. 2 is a block diagram illustrating a travel sessionizer, according to an embodiment.

FIG. 3 is a block diagram illustrating a profit optimization module, according to an embodiment.

FIG. 4 is a block diagram illustrating a pricing rules engine, according to an embodiment.

FIG. 5 is a block diagram illustrating a profit optimization processing flow, according to an embodiment.

FIG. 6 is a flow diagram illustrating a competitor set determination method, according to an embodiment.

FIG. 7 is a flow diagram illustrating a dynamic sub-rate price discount adjustment method, according to an embodiment.

FIG. 8 is a flow diagram illustrating a dynamic room type price modifier adjustment method, according to an embodiment.

FIG. 9 is a block diagram illustrating a computer system, according to an embodiment.

### DETAILED DESCRIPTION OF THE PRESENT INVENTION

The following description sets forth numerous specific details such as examples of specific systems, components, methods, and so forth, in order to provide a good understanding of several embodiments of the present invention. It will be apparent to one skilled in the art, however, that at least some embodiments of the present invention may be practiced without these specific details. In other instances, well-known components or methods are not described in detail or are presented in simple block diagram format in order to avoid unnecessarily obscuring the present invention. Thus, the specific details set forth are merely exemplary. Particular implementations may vary from these exemplary details and still be contemplated to be within the scope of the present invention.

Embodiments of a method and apparatus are described for open pricing and pricing rules for travel properties. In one embodiment, a pricing rules engine in a travel property revenue management system receives a calculated bid price and enforces a set of one or more pricing rules (also referred to herein as “post-optimization rules”) that may alter the bid price. The bid price may be calculated based on a number of factors including historical data, estimated demand, lost business data, etc., and may be designed to optimize a profit for the travel property. For a variety of reasons, a user of the revenue management system, may want to set an actual price for a room at the travel property that varies from the calculated bid price. In order to do so, the user of the system (e.g., a property manager) may set or configure a number of pricing rules. In other embodiments, the pricing rules may be dynamically determined by the pricing rules engine, or may be default rules set by the system for a group of one or more travel properties.

In one embodiment, the pricing rules may be influenced by a competitor set. The competitor set may include a group of travel properties that are deemed to be relevant competitors for the target travel property based on one or more rule conditions. The rule conditions may include factors that affect which travel properties are included in the current competitor set. These factors can include, for example, a day of the week, a season of the year, a travel property rate code, a travel property room time, or other factors. A specific combination of these factors can lead to a unique competitor set which may best inform the user about what prices his competitors are charging. In one embodiment, the pricing rules engine may maintain different competitor sets for each combination of rule conditions and may dynamically update the competitor set and/or switch between competitor sets based on a change to the rule conditions.

Examples of pricing rules enforced by the pricing rules engine include rules for sub-rate price discounts and room type price modifiers. Both types of pricing rules may be influenced by the prices obtained from the associated competitor set. For example, one pricing rule may be that the sub-rate price discount or the room type price modifier be no more than the average price of the travel properties in the corresponding competitor set. Depending on the rule conditions (e.g., day of the week or room type), the relevant competitor set may be different. The pricing rules engine can dynamically update the competitor set to ensure that the most accurate price is determined. In addition, users have increased granular control over pricing for their travel properties and can implement specific pricing rules based on any unique combination of rule conditions.

In one embodiment, the pricing rules engine in the travel property revenue management system enforces the pricing rules (which may be default rules, or may be controlled by the individual user), and calculates an actual price for a given room at a given property on a given day. Rather than just notifying the user (e.g., hotel manager), when one of the pricing rules has been triggered and requiring the user to manually adjust the price, in one embodiment, the pricing rules engine automatically adjusts the offer price for the given room at the given hotel on the given day without requiring any user action. The pricing rules engine may optionally notify the user that the rule has taken affect and that the price has been adjusted accordingly, however, the user need not take any manual action to adjust the price.

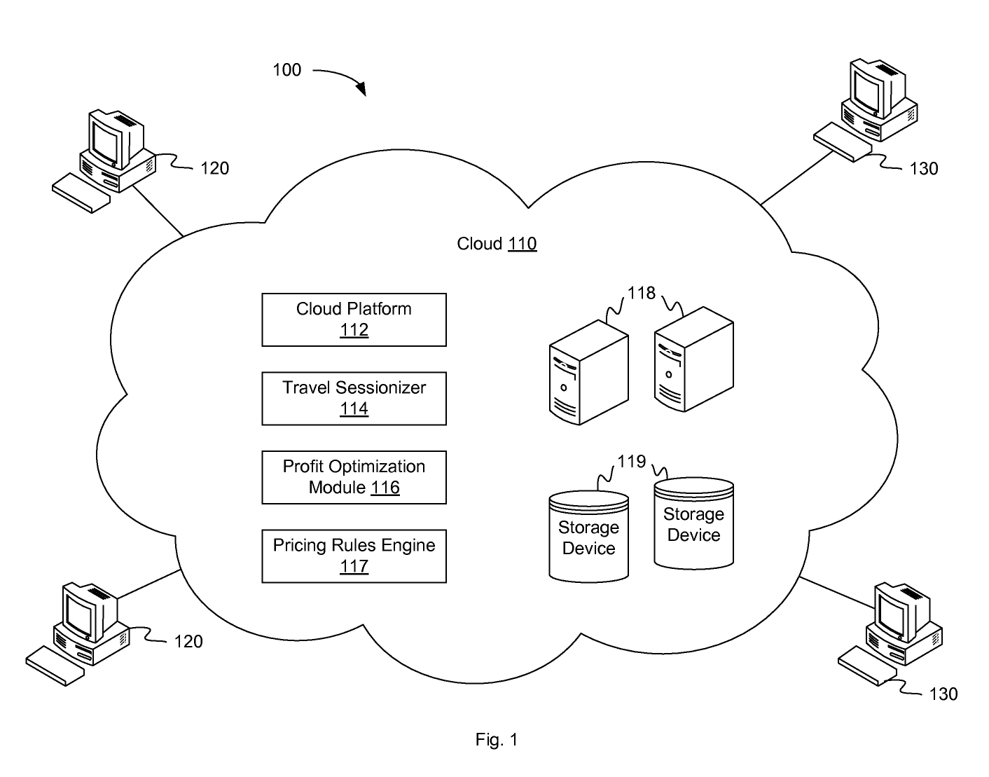

FIG. 1 is a block diagram illustrating a cloud computing environment for a multi-tenant cloud architecture, according to an embodiment of the present invention. In one embodiment, cloud computing environment 100 includes cloud 110, one or more user devices 120, and one or more property devices 130. User devices 120 and property devices 130 may be used to access the resources of the cloud 110, and may include, for example, personal computers (PCs), workstations, laptop computers, tablet computers, mobile phones, personal digital assistants (PDAs) or the like. In one embodiment, user devices 120 may be personal computing devices used by individuals to shop for or browse travel properties (e.g., hotels, motels, bed and breakfasts, condominiums, houses). Property devices 130 may be computing devices used by property managers, owners, or employees to access demand forecasting, profit maximization or other resources available in cloud 110. Cloud 110 may include a group of networked computing resources accessible to the user devices 120 and property devices 130 over a network, such as a local area network (LAN), a wide area network (WAN), a global area network (GAN) such as the Internet, or a combination of such networks. The resources available in the cloud 110 may include, for example, processing devices, storage devices, applications, or other resources. The cloud 110 allows for a functional separation between the computing resources used, the user devices 120 where a user is working, and the property devices 130 where a property manager or owner is working. The cloud 110 may provide access to a vast network of computing resources and allow individuals to use data or resource intensive applications driven by cloud technology which may or may not be available locally given the limitations of the user devices 120 or the property devices 130.

In one embodiment cloud 110 includes cloud platform 112, travel sessionizer 114, profit optimization module 116, pricing rules engine 117, one or more application servers (or application server instances) 118, and one or more storage devices 119. Each of these resources may be located at the same location or at different locations, and may be connected to one another and/or to user devices 120 and property devices 130 through the network, as discussed above. Storage devices 119 may be, for example, memory, such as read-only memory (ROM), flash memory, random access memory (RAM), etc., or mass storage devices, such as a magnetic or optical storage devices, or a combination thereof. In one embodiment, user devices 120 and property devices 130 may interact directly with could platform 112. Cloud platform 112 may include software configured to provide access to the other resources in the cloud 110. Cloud platform 112 may cause the cloud resources, such as application servers 118 or storage devices 119, to appear, for example, as web pages or as virtual machines on user devices 120 or property devices 130.

Cloud platform 112 may pass messages between user devices 120 and property devices 130, and travel sessionizer 114, profit optimization module 116, and pricing rules engine 117. In one embodiment, travel sessionizer 114 captures raw event data from the travel shopping actions of users on user devices 120 and parses the raw event data into separate travel sessions. In one embodiment, a travel session includes the shopping, browsing, searching etc., done by one individual (or on one of user devices 120) for travel on a set of similar dates. For example, a travel session may include the searches performed by a user for travel over a certain weekend, or travel within several days of that weekend. The data associated with the search, including, for example, a destination city, specific properties, dates of arrival, length of stay, room type, property amenities, price quotes, availability information, and/or other travel information, may be included in a specific travel session associated with the user. Thus, the data in a given travel session is associated with a single trip. Travel sessionizer 114 may store this travel session data on one of storage devices 119 in cloud 110. If travel sessionizer 114 determines that the user makes additional searches for the same trip, travel sessionizer 114 may add any additional data to the same travel session. Additional details regarding travel sessionizer 114 will be provided below.

In one embodiment, profit optimization module 116 uses the travel session data identified by travel sessionizer 114 to forecast the demand at a given property on a certain date and determine a price for rooms at the property on that date that will increase or optimize the profit. Property managers, owners or employees using property devices 130 can access the findings of profit optimization module 116 and choose to implement the suggested prices in the sale of rooms at the property. Additional details regarding profit optimization module 116 will be provided below.

In one embodiment, pricing rules engine 117 interacts with profit optimization module 116 and travel sessionizer 114 to enforce a set of one or more pricing rules (also referred to herein as “post-optimization rules”). The pricing rules may be set or configured by a user of the system (e.g., a property manager), may be dynamically determined by the system, or may be default rules set by the system for a group of one or more travel properties. The pricing rules may be used to alter, adjust or otherwise change a bid price, shadow price, or other price calculated by the system. For example, the user may have specific reasons for why he wishes to have the price of a room at his property vary from the calculated optimal price (e.g., to stay below a certain competitor), and pricing rules engine 117 can effect this variance using the pricing rules. Additional details regarding pricing rules engine 117 will be provided below.

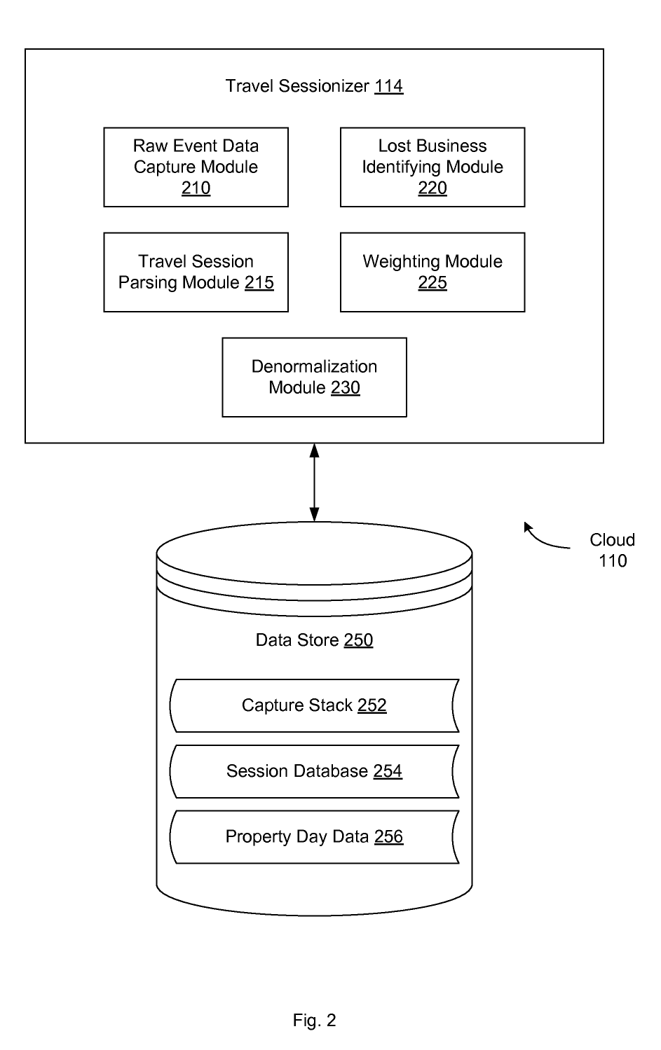

FIG. 2 is a block diagram illustrating a travel sessionizer, according to an embodiment of the present invention. In one embodiment, travel sessionizer 114 may be implemented by one of application servers 118 in cloud 110, as shown in FIG. 1. In one embodiment, travel sessionizer 114 includes raw event data capture module 210, travel session parsing module 215, lost business identifying module 220, weighting module 225, and denormalization module 230. In one embodiment, travel sessionizer 114 is connected to a data store 250, which may be a file system, database or other data management layer resident on a data storage device, such as one of storage devices 119, and may include a disk drive, RAM, ROM, database, etc.

In one embodiment, raw event data capture module 210 captures raw event data from users who are shopping, browsing, searching, etc. for travel on one of user machines 120. In one embodiment, a user may search for a property using a travel website running in a web browser. The web browser may use cookies or some other tracking mechanism to capture the raw event data. The raw event data may include an indication of the criteria that the user puts into each travel search. For example, the raw event data may include a destination city, specific properties, dates of arrival, length of stay, room type, property amenities, price quotes, availability information, and/or other travel information. The web browser may transmit these cookies to travel sessionizer 114 where they are received by raw event data capture module 210. In one embodiment, raw event data capture module 210 stores the raw event data in a capture stack 252 in data store 250.

In one embodiment, travel session parsing module 215 parses the raw event data in capture stack 252 into individual travel sessions. In one embodiment, a travel session includes the shopping, browsing, searching, etc., done by one individual (or on one of user devices 120) for travel on a set of similar dates. For example, travel session parsing module 215 may associate all searches done from a single user device 120, with one individual. The user device 120 may be identified, for example, using a fingerprinting technique to identify a unique combination of Internet Protocol (IP) address, browser type, and/or other features associated with an individual. In another embodiment, travel session parsing module 215 may identify an individual using cookies (either first party cookies from a particular travel website, or third party cookies shared across multiple websites), or using login information (e.g., a unique identifier and password combination). The date component of the travel session may be based upon the dates for which the user is searching for travel information. For example, all searches done by the user for the same dates may be considered part of the same travel session. In one embodiment, searches done for dates that are in close proximity, but not exactly the same, may also be included in the same travel session. For example, travel session parsing module 215 may be configured with a threshold (e.g., +/−2 days) for the start and end of a trip. If the user searches for travel on dates that fall within the threshold, travel session parsing module 215 may consider that search to be part of the same travel session. In one embodiment, travel session parsing module 215 stores the travel data corresponding to each travel session in session database 254 of data store 250.

In one embodiment, lost business identifying module 220 identifies instances of lost business from the data in session database 254. Lost business may include, for example, regrets and denials. A regret occurs when an individual is offered a property on a given night for a certain price, but for some reason does not actually book the property. A denial occurs when the individual expresses an interest in booking a property of the given night, but is unable to do so, because, for example, the property is sold out or the requested room type is unavailable. Lost business identifying module 220 can analyze the shopping behaviors of an individual to determine when regrets and denials occur. Lost business identifying module 220 may add an indication of a regret or denial for a particular property to the corresponding entry in session database 254 in response to this determination.

Weighting module 225 may make a determination of the strength of a regret or denial and may assign a corresponding weighting value. For example, each of regrets and denials may be divided into different tiers, where each tier has a different weighting value. In one embodiment, with respect to denials, a first tier with a lower weighting value may include a property that was not included in a list of properties displayed to a user. A second tier, with a higher weighting value, may include a property that was specifically searched for by a user, but was sold out, and the user does not book another property on the same or similar dates. A third tier, with a highest weighting value indicating a strongest denial, may include a property that was specifically searched for by a user, but was sold out, and the user goes on to book another property on the same or similar dates. Weighting module 225 may add the weighting value for the regret or denial to the corresponding entry in session database 254.

In one embodiment, denormalization module 230 denormalizes the data in session database 254 to determine the number of regrets and denials for a given property on a certain day. Denormalization module 230 may read each entry in session database 254 to determine if there are any regrets or denials indicated. For each regret or denial, denormalization module 230 may increment a count value for an entry in property day data 256. In property day data 256, there may be a separate entry for each day at each property. The values in each entry represent the number of regrets and denials determined for the associated day at the associated property. In one embodiment, the number of regrets and denials are combined into a single count value. In other embodiments, however, each entry in property day data 256 may have a separate count value for each of regrets and denials.

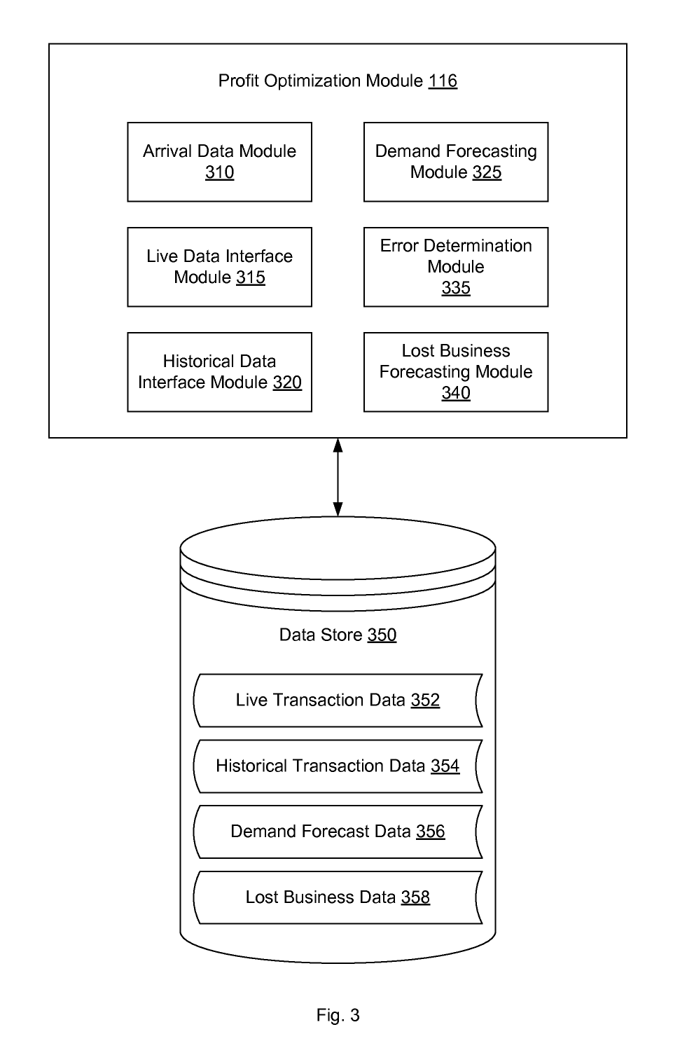

FIG. 3 is a block diagram of one embodiment of a profit optimization module 116 that is included in cloud 110 of FIG. 1. In one embodiment, profit optimization module 116 may include arrival data module 310, live data interface module 315, historical data interface module 320, demand forecasting module 325, error determination module 335 and lost business forecasting module 340. In one embodiment, profit optimization module 116 is connected to a data store 350, which may be a file system, database or other data management layer resident on a data storage device, such as one of storage devices 119, and may include a disk drive, RAM, ROM, database, etc.

In one embodiment, arrival data module 310 determines the day of the week for the designated day of arrival. In one embodiment, arrival data module 310 receives a user selection (e.g., through a user interface) indicating the day of arrival. The day of arrival will be the day for which demand will be forecasted. For example, the day of the week of the day or arrival may be a Saturday. Arrival data module 310 also determines a forecast period based on the length of time between the current day and the day of arrival. For example, if the current day is a Monday, arrival data module 310 may determine that the forecast period between now and the following Saturday is five days. Thus, the forecast period for the current forecast may be set at five days.

In one embodiment, historical data interface module 320 determines the number of bookings made during the forecast period in some number of previous weeks. In one embodiment, the number of previous weeks may be a default value (e.g., 13 weeks) or the number of previous weeks may be user configurable. In other embodiments, the number of previous weeks examined may be varied depending on a number of factors, such as the season, the location of the property, etc. In one embodiment, historical data interface module 320 may examine the forecast period (e.g., 5 days) prior to the day of week (e.g., Saturday) for the current day of arrival in each of the previous 13 weeks. Historical data interface module 320 may determine how many bookings were made during that period during each of the 13 weeks.

In one embodiment, demand forecasting module 325 combines the number of bookings determined from the previous weeks using a selected forecasting method. In one embodiment, the forecasting method used may be a default method, may be a user-selected method, may be a method selected based on a minimization of forecasting error, or may be some other method. For example, the forecasting method may be regression, a moving average, exponential smoothing, Bayesian, or some other forecasting method. As a result of combining these bookings from the historical transaction data 354, demand forecasting module 325 estimates the number of additional bookings that will be made in the current forecast period. Demand forecasting module 325 may add the estimate from to the number of bookings already made for the day of arrival. The number of bookings already made may be determined by live data interface module 315 from live transaction data 352. By adding the estimated bookings between the current data and the day of arrival to the number of bookings already made, demand forecasting module 325 can estimate what the total demand will be for the day of arrival. Demand forecasting module 325 may store this information as demand forecast data 356.

In one embodiment, error determination module 535 may select one of the available forecasting methods or receive an indication of a selected forecasting method from a user. In one embodiment, the forecasting methods may include, for example, regression, a moving average, exponential smoothing, Bayesian, or some other forecasting method. Error determination module 335 compares the demand forecast for a prior day to the actual demand data for that day. In one embodiment, error determination module 335 reads historical transaction data 354 for the previous Saturday and compares that data to the demand forecast data 356 calculated for that day.

Error determination module 335 may determine a forecasting error for the demand forecast based, for example, on a median absolute deviation, a mean absolute percentage error, or by some other method. The median absolute deviation may be expressed as the median of the absolute deviations of each sample in the data from the data's median. The mean absolute percentage error may be expressed as the sum, for each forecasted value, of the difference between the actual value and the forecasted value divided by the actual value, all of which is multiplied by 100 to determine a percentage error. In general the lower either the median absolute deviation or the mean absolute percentage error, the more accurate the forecast was. Error determination module 335 may also combine (e.g., average, weighted average, etc.) the forecasting errors for each day that is tested in order to determine an overall forecasting error for the selected forecasting method. In one embodiment, error determination module 335 may test all possible configurations, or some subset of configurations (e.g., each of the different forecasting methods), to determine which configuration has the lowest forecasting error. In one embodiment, error determination module 335 determines which configuration resulted in the lowest forecasting error (i.e., based on either median absolute deviation or a mean absolute percentage error). Profit optimization module 116 selects the configuration to use to forecast the demand for the current day of arrival (e.g., this coming Saturday). In one embodiment, profit optimization module 116 may perform these steps prior to each demand forecast that is made. In this manner, the forecasting method and associated configuration is dynamically selected to give the best possible forecast.

In one embodiment, lost business forecasting module 340 examines the lost business data 358 and compares those numbers to historical transaction data 354 for the same period. For example, if during the forecasting period from the previous week, there were 200 regrets and denials and 10 actual bookings, lost business forecasting module 340 can determine a conversion rate of 5%. In one embodiment, lost business forecasting module 340 may determine the average conversion rate over the same or a different number of previous weeks. In one embodiment, lost business forecasting module 340 performs a method using lost business data instead of actual bookings. For example, lost business forecasting module 340 may use a forecasting method, such as one of regression, a moving average, exponential smoothing, Bayesian, or some other forecasting method to mathematically combine the historical regrets and denials, and generate an estimate of how many regrets and denials will occur during the current forecast period (i.e., between now and the day of arrival). Lost business forecasting module 340 applies the historical conversion rate to the estimated number of regrets and denials to determine an estimated number of bookings. For example, if there are an estimated 300 regrets and denials during the forecast period and the historical conversion rate is 5%, then lost business forecast module 340 may determine that there will be an estimated 15 additional bookings during the forecast period. This represents the number of expected bookings, assuming that the number of regrets and denials followed historical norms.

In one embodiment, live data interface module 315 can retrieve the current regrets and denials from live transaction data 352, and lost business forecasting module 340 applies the historical conversion rate determined to the live regrets and denials. For example, if the actual number of regrets and denials is 250, lost business forecasting module can multiply that number by 5% to determine that there will likely be 12 bookings resulting from those regrets and denials. Lost business forecasting module 340 determines the difference between the two estimates. In this example, there are 3 less estimated bookings based on the actual lost business information as compared to the historical lost business information. In one embodiment, lost business forecasting module 340 subtracts the 3 bookings from the demand forecast. This adjustment based on the lost business forecast, may result in a more accurate demand forecast for the property.

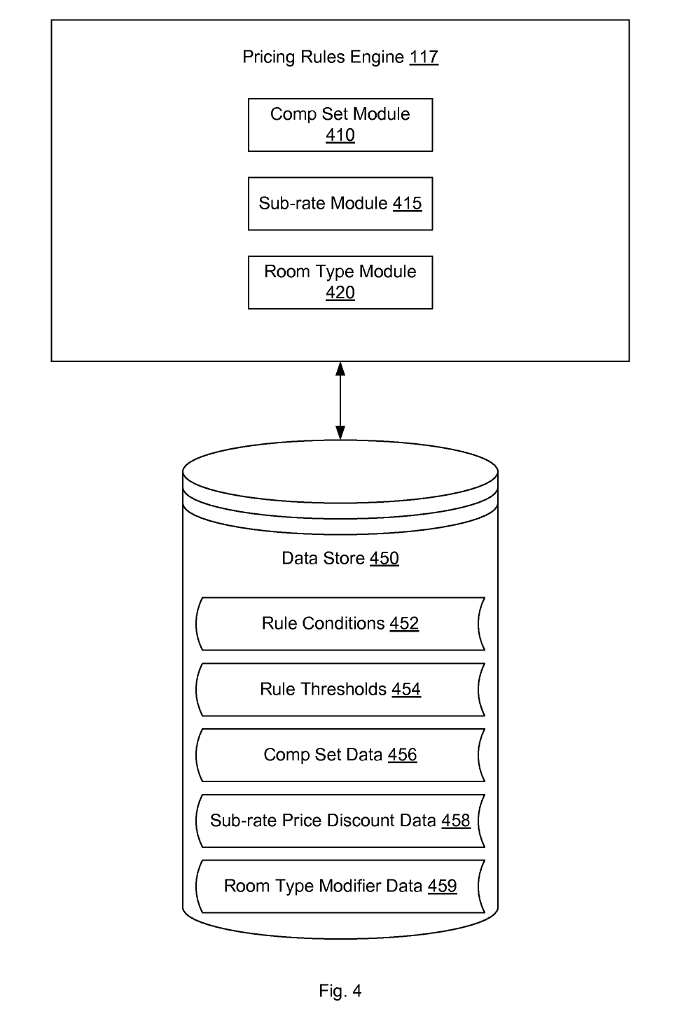

FIG. 4 is a block diagram illustrating a pricing rules engine 117, according to an embodiment of the present invention. In one embodiment, pricing rules engine 117 may be implemented by one of application servers 118 in cloud 110, as shown in FIG. 1. In one embodiment, pricing rules engine 117 includes competitor set module 410, sub-rate module 415 and room type module 420. In one embodiment, pricing rules engine 117 is connected to a data store 450, which may be a file system, database or other data management layer resident on a data storage device, such as one of storage devices 119, and may include a disk drive, RAM, ROM, database, etc.

In one embodiment, competitor set module 410 handles the generation and management of dynamic competitor sets (comp sets). Each competitor set 456 may include one or more competitors deemed relevant to a given travel property based on a set of rule conditions 452. The rule conditions 452 may include factors that affect which travel properties are included in the current competitor set 456. These factors can include, for example, a day of the week, a season of the year, a travel property rate code, a travel property room time, or other factors. Depending on a certain combination of these factors, different competitors may be most relevant to the given travel property. For example, a certain group of properties may be more relevant competitors in the summer, while a different group is more relevant in the winter. Similarly, a given travel property may compete with one group of properties for more expensive suite customers and with another group for cheaper standard room customers. In another embodiment, a given travel property may have one group of properties in a weekday competitor set and a second group of properties in a weekend competitor set. Thus, competitor set module 410 may maintain different competitor sets 456 for each combination of rule conditions 452.

In one embodiment, competitor set module 410 determines the individual travel properties to be included in each competitor set 456 by performing a pricing correlation on a group of potential competitors. The potential competitors may include other travel properties that share similar attributes, such as location, size, rating, etc. In one embodiment, the potential competitors may include those travel properties listed as competitors by a third party service, such as Smith Travel Research, Inc. In one embodiment, to perform the pricing correlation, competitor set module 410 may compare the listed prices for each of the potential competitors to the prices of the target travel property according to the rule conditions 452. For example, if the rule conditions 452 specify a standard room on a Saturday during the summer, competitor set module 410 may determine the prices charged by each of the potential competitors under the same conditions and determine which are most comparable to the price of the target travel property. In one embodiment, competitor set module 410 may include a set number of competitors in the competitor set 456 (e.g., the top 5, or the top 10%). In another embodiment, competitor set module 410 may include any competitor that is within a certain threshold difference from the price of the target travel property (e.g., +/−$25 or +/−% 15). In one embodiment, the user may be able to alter the default competitor set or otherwise define their own competitor set. For example, the user may select which particular properties to include or exclude from a competitor set for a given set of rule conditions.

In another embodiment, competitor set module 410 may also take into account the period of time between the day on which the booking was made and the day of arrival (i.e., the day when travel will occur). The above rule conditions may be used to sort the day of booking, the day of arrival, or both. For example, during pricing correlation, competitor set module 410 may compare the prices charged by the potential competitors for travel on a Saturday in the summer on a day two weeks prior to the actual day of arrival, or during a range of days prior to the day of arrival. It may be the case that the target hotel has different sets of competitors for bookings made at different times, such as for more than two weeks ahead of time and for last minute bookings (e.g., less than two weeks ahead of time). Thus, in one embodiment, the period of time prior to arrival that the booking is made (or the price is listed) may be another factor in rule conditions 452. In another embodiment, the capacity of the hotel or the forecasted demand for the day of arrival may also be rule conditions. For example, different competitor sets may be defined for when the bookings at the property are above or below a certain level or when the forecasted demand is above or below a given threshold.

In one embodiment, sub-rate module 415 controls the sub-rate price discounts 458 that are offered for the target hotel. Sub-rate price discounts may include discounts offered by the travel property off of a standard rate (sometimes referred to as “Best Available Rate” (BAR)). For example, members of certain organizations (e.g., AAA) may receive a discount off of the standard rate, corporate customers traveling on business may receive a discount, or customers who book a hotel as part of a travel package (e.g., hotel+airfare) may receive a discount. Individually, the rates these customers are offered may be referred to as sub-rates and the difference between the sub-rates and the standard rate (i.e., a rate available to all customers without any discount) may be the sub-rate price discount. In one embodiment, sub-rate module 415 allows for different sub-rate price discounts to be offered to different groups of customers. The sub-rate price discounts may be expressed as a dollar value (e.g., $25) or a percentage (e.g., % 10).

In one embodiment, sub-rate module 415 determines an offer price for a booking at the target travel property. The offer price may be obtained from one of travel sessionizer 114 or profit optimization module 116. In another embodiment, the offer price may be input by a user of pricing rules engine 117. In one embodiment, a calculated shadow price represents the highest price that a property can charge for an extra room at the property (and have the room be booked) based on the forecasted demand. For example, if the offer price for a room at the property is above the shadow price, it is unlikely that a booking will result, because the demand forecast cannot support that price. If the offer price is below the shadow price, the room will likely be booked, but the property could likely have gotten a higher price for the room. If the offer price is equal to the shadow price, the property can likely optimize its profit, by obtaining a booking at the highest possible price for the extra room. In one embodiment, the shadow price is determined based on prices charged in historical transactions and adjusted based on the forecasted demand. For example, if the forecasted demand is higher than the actual demand was at a certain time in the past, the shadow price may be increased from what the actual offer price was at that time in the past.

Sub-rate module 415 may compare the offer price (or shadow price) to a rule threshold 454. The rule threshold may be a price point at which a given pricing rule takes effect. Since the offer price is based on demand, as the compression at a travel property increases (i.e., as the travel property approaches its maximum capacity), the offer price will normally increase as well. Thus, in one embodiment, once the offer price increases above a given threshold, a travel property may reduce (or otherwise adjust) the sub-rate price discounts accordingly. In one embodiment, rather than closing out a particular sub-rate (i.e., not offering any rooms in the associated category), sub-rate module 415 may reduce the corresponding sub-rate discount to a lower amount, or potentially to zero. Thus, rooms at that sub-rate may still be available, even if the sub-rate price is close to or equal to the standard rate. In one embodiment, the rule threshold may be defined according to other factors, such as bookings at the property or the forecasted demand for the day of arrival. For example, a certain rule may go into effect when the bookings at the property are above or below a certain level or when the forecasted demand is above or below a given threshold. In one embodiment, a pricing rule may end when the property reaches a certain percentage of capacity or some number of days prior to the day of arrival.

In one embodiment, sub-rate module 415 adjusts the sub-rate price discounts 458 according to rates charged by competitor travel properties in the identified competitor set. As discussed above, the competitor set may take into account certain rule conditions 452. Similarly, the rule threshold 454 may be specific to a set of rule conditions. For example, the rule threshold 454 may be set to a first value for weekdays and to a second value for weekends. In other embodiments, some other combination of one or more rule conditions 452 may be used. In one embodiment, a sub-rate discount rule enforced by sub-rate module 415 may specify that when the rule threshold is met 454, the sub-rate price discount should be set based on rates from the competitor set. For example, the sub-rate price discount may be set in order to match a representative (e.g., average, highest, lowest) price from the competitor set 456. In another embodiment, the sub-rate price discount may be set to be a certain amount higher or lower than the representative price. The sub-rate price discount rule may be configured by the user to include any adjustment to the sub-rate price discount based on the competitor set. Sub-rate module 415 may enforce different rules, using different rule thresholds 454, and different sub-rate price discounts 458, for any set of rule conditions 452. In one embodiment, sub-rate module 415 adjusts the sub-rate price discounts 458 according to rates charged by the same hotel for different segments. For example, the sub-rate price discount for one segment may be set in order to match the price of another segment, to be a certain amount higher or lower than another segment or to have an offset from another segment that is equal to the offset between other segments.

In one embodiment, room type module 420 controls room type price modifiers 459 that are offered for the target hotel. Room type price modifiers may include increases or decreases offered by the travel property off of a standard rate for different room types. For example, a standard room (e.g., a room with one king size bed) may be priced at a standard rate. Different rooms types may be priced based on that standard rate. For example, a room with two queen size beds, a junior suite, or a full suite may have different prices, which may be expressed in terms of a dollar amount or percentage increase from the standard rate. The difference between the rates for each room type and the standard rate may be referred to as a room type price modifier. In one embodiment, room type module 420 allows for different room type modifiers to be offered for different room types.

In one embodiment, room type module 420 determines an available capacity of a given room type at a travel property. The capacity may be obtained from one of travel sessionizer 114 or profit optimization module 116. In another embodiment, the capacity may be input by a user of pricing rules engine 117. In one embodiment, the available capacity represents the number of unsold rooms of a particular room type on a given day at the travel property.

Room type module 420 may compare the capacity to a rule threshold 454. The rule threshold may be a capacity at which a given pricing rule takes effect. In one embodiment, once the capacity decreases below a given threshold (or bookings or forecasted demand increases above a given threshold), a travel property may wish to adjust the room type price modifier 459 accordingly. In one embodiment, room type module 420 adjusts the room type price modifier 459 according to rates charged by competitor travel properties in the identified competitor set. As discussed above, the competitor set may take into account certain rule conditions 452. Similarly, the rule threshold 454 may be specific to a set of rule conditions. For example, the rule threshold 454 may be set to a first value for weekdays and to a second value for weekends. In other embodiments, some other combination of one or more rule conditions 452 may be used. In one embodiment, the rule threshold may be defined according to other factors, such as bookings at the property or the forecasted demand for the day of arrival. For example, a certain rule may go into effect when the bookings at the property are above or below a certain level or when the forecasted demand is above or below a given threshold. In one embodiment, a pricing rule may end when the property reaches a certain percentage of capacity or some number of days prior to the day of arrival. In one embodiment, a room type modifier rule enforced by room type module 420 may specify that when the rule threshold is met 454, the room type price modifier should be set based on rates from the competitor set. For example, the room type price modifier may be set in order to match a representative (e.g., average, highest, lowest) price from the competitor set 456. In another embodiment, the room type price modifier may be set to be a certain amount higher or lower than the representative price. The room type price rule may be configured by the user to include any adjustment to the room type price modifier based on the competitor set. Room type module 420 may enforce different rules, using different rule thresholds 454, and different room type price modifiers 459, for any set of rule conditions 452. In one embodiment, room type module 420 adjusts the room type price modifiers 459 according to rates charged by the same hotel for different segments. For example, the room type price modifier for one segment may be set in order to match the price of another segment, to be a certain amount higher or lower than another segment or to have an offset from another segment that is equal to the offset between other segments.

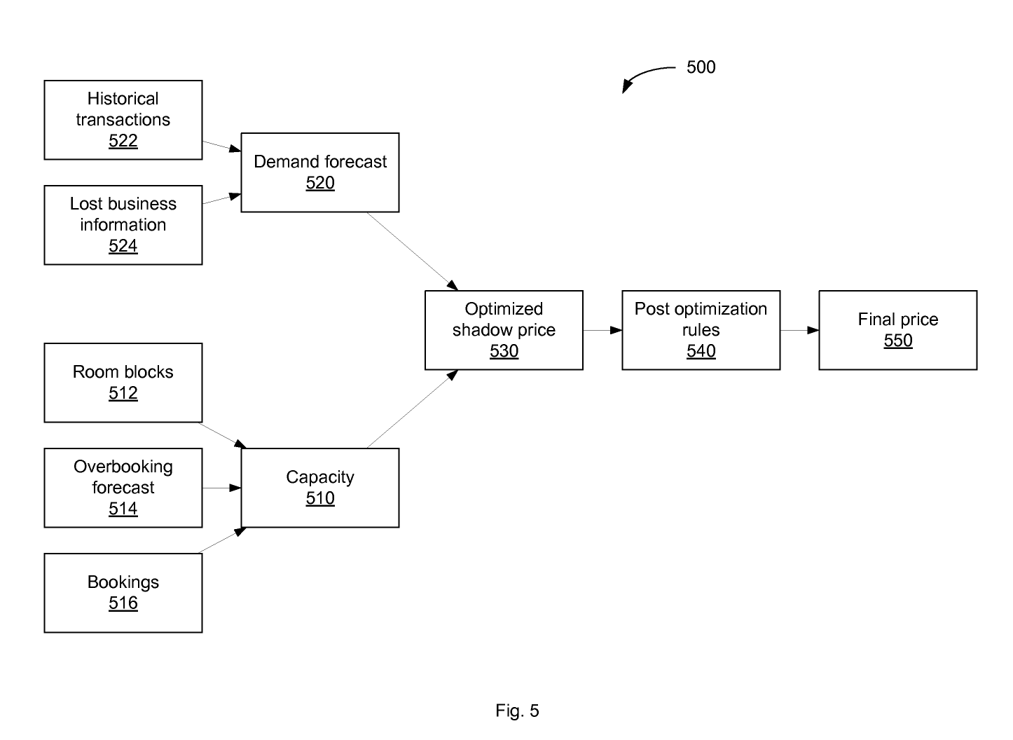

FIG. 5 is a block diagram illustrating a profit optimization processing flow, according to an embodiment of the present invention. The various modules and components may be described in regards to their roles in determining a price for one unit of lodging (e.g., a hotel room) that will optimize the profit for the owner of the property.

In one embodiment, the processing flow 500 begins with determining a capacity for the property on a given day at block 510. In one embodiment, for ease of explanation, the day for which the capacity is determined may be referred to as the “day of arrival” or the “arrival day,” although it should be understood that a guest need not necessarily arrive at the property on that day, but rather just make a reservation for that day/night. For example, the guest may have checked-in to the property on an earlier day, but their stay includes the “day of arrival.” The capacity may take into account several factors including, among others, the physical number of rooms in the property, room blocks 512, an overbooking forecast 514, and previous bookings 516. Room blocks 512 may include blocks of rooms (or other lodging units) that are being held or reserved for a specific guest or group, but have not been officially booked. For example, commonly a block of rooms may be reserved for guests of a wedding or attendees of a conference, while the individuals may actually book the rooms themselves at a later date. The overbooking forecast 514 may designate a number of rooms or a percentage of rooms of the actual physical capacity of the hotel that may be booked to account for cancelations and no-shows. In one embodiment, there is a default number of rooms (e.g. 5) or a percentage of the total rooms in the property (e.g., 5%) that may be overbooked. In another embodiment, the overbooking forecast 514 may include an estimate of how many rooms to overbook based on historical trends for cancelations and no-shows. Previous bookings 516 may a number of rooms that were previously booked by guests for the day of arrival. These bookings may be subtracted from the physical capacity of the property in order to determine the capacity 510 for the property on the day of arrival. In one embodiment, room blocks 512, the overbooking forecast 514 and previous bookings 516 are obtained from a booking engine or central reservation system associated with the property.

At block 520, the demand for lodging units is forecasted for the day of arrival. In one embodiment, historical transactions 522 and lost business information 524 are combined to determine the demand forecast 520. Historical transactions 522 may include the number of bookings made at the property in the past. In one embodiment, trends may develop over time for the same day of the week. Thus, historical transactions 522 may include, for example, the number of bookings made for the same day of the week as the day of arrival during some number of previous weeks. In another embodiment, historical transactions 522 may include the number of bookings made within some period of time (e.g., 5 days) of the day of arrival during some number of previous weeks. In other embodiments, some other historical transaction data may be used. Lost business information 524 may include regrets and denials that did not result in an actual booking for the property. Regrets are generated when a potential customer searches for or inquires about a room at the property but does not ultimately book the room. Denials are generated when a potential customer is unable to book a room because either the property or the specific room type that they are searching for is sold out or otherwise unavailable on the day of arrival. This lost business information 524 can be informative of the interest in the property on the day in question and may affect the demand forecast 520. In one embodiment, historical transaction data 522 may be obtained from the booking engine or central reservation system associated with the property, and lost business information 524 may be obtained from travel sessionizer 114, as described above. Additional details of the demand forecast 520 will be described below.

The capacity 510 and the demand forecast 520 are combined to generate the optimized shadow price 530. In one embodiment, the shadow price represents the highest price that a property can charge for an extra room at the property (and have the room be booked) based on the forecasted demand 520. For example, if the offer price for a room at the property is above the shadow price, it is unlikely that a booking will result, because the demand forecast 520 cannot support that price. If the offer price is below the shadow price, the room will likely be booked, but the property could likely have gotten a higher price for the room. If the offer price is equal to the shadow price, the property can likely optimize its profit, by obtaining a booking at the highest possible price for the extra room. In one embodiment, the shadow price is determined based on prices charged in historical transactions 522 and adjusted based on the forecasted demand. For example, if the forecasted demand is higher than the actual demand was at a certain time in the past, the shadow price may be increased from what the actual offer price was at that time in the past.

After the optimized shadow price 530 is determined, pricing rules engine 117 may enforce additional post optimization rules 540. Post optimization rules 540 can be used to vary the final price 550 from the optimized shadow price 530 according to preferences of the property owner/manager. Post optimization rules 540 may have default settings or alternatively may be controlled by the property owner/manager or by any user of the pricing rules engine 117. In one embodiment, price elasticity and the propensity of customers to pay a certain price, can be determined from the lost business data 524. This information can be incorporated in the post optimization rules 540 to modify the optimized shadow price 530. For example, if the shadow price 530 for the day of arrival is $100, but it is determined that customers in a specific segment are price insensitive for that day (e.g., if they are coming on business and they are on an expense account), the final price 550 can be adjusted above $100. If by looking at the data, it is determined that the customers in a segment are indifferent to paying $109 or $139 for a room (this may be seen in the data aggregated for a market), then a post optimization rule 540 for that day can modify the original $100 shadow price 530 into a $139 final selling price 550 for that segment. In one embodiment, pricing rules engine 117 can implement a different rule for each set of rule conditions, which may include, for example, the day of the week, the season, the rate code or the room type.

In another embodiment, the post optimization rules 540 can also be based on marketing or management decisions. For example, the manager of a property may want rooms at his hotel to be priced on a specific channel at least $10 above a competing property or group of properties in a competitor set. A post optimization rule 540 may be set to increase the final price 550 to $10 above a representative price of the competitor set for the day of arrival. Other post optimization rules 540 can deal with minimum selling rate by day of week and/or season or a maximum selling rate (e.g., the marketing department always wants to make sure the price 550 never goes below a given price or above another price). The final price 550, as modified by pricing rules engine 117 using the post optimization rules 540 may be displayed to customers in a given segment for the day of arrival. In one embodiment, the final price 550 as determined in view of post optimization rules 540, is automatically published to various shopping outlets (e.g., the hotel website, third party travel websites, etc.). Rather than just notifying the user (e.g., hotel manager), when one of the pricing rules has been triggered and requiring the user to manually adjust the price, in one embodiment, the pricing rules engine automatically adjusts the final price 550 without requiring any user action. The pricing rules engine may optionally notify the user that the rule has taken affect and that the final price 550 has been adjusted accordingly, however, the user need not take any manual action to adjust the price. In one embodiment, if the user wishes to override the final price 550, he may optionally be able to reverse the adjustment and revert to the optimized shadow price 530 or to some other price.

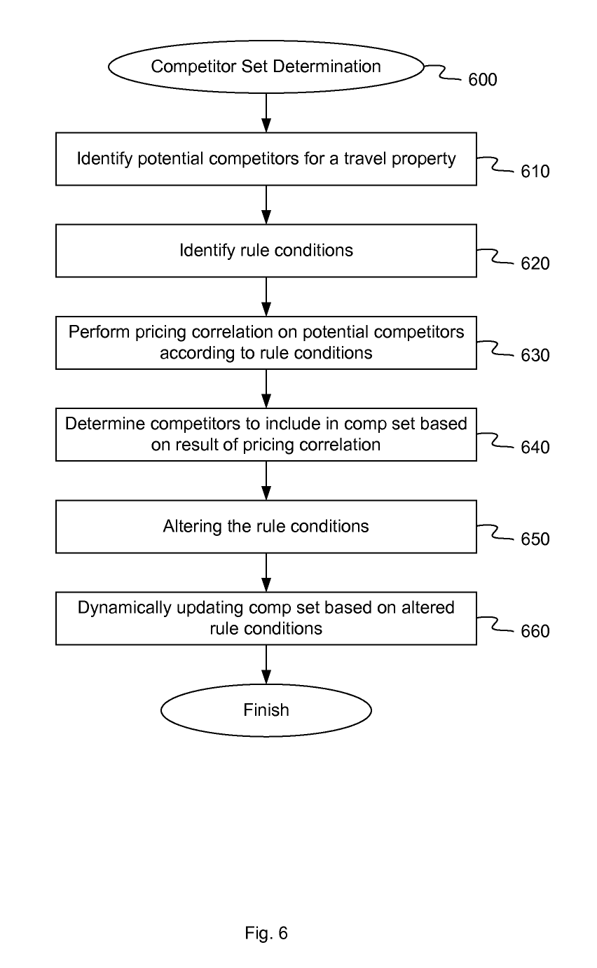

FIG. 6 is a flow diagram illustrating a competitor set determination method, according to an embodiment of the present invention. The method 600 may be performed by processing logic that comprises hardware (e.g., circuitry, dedicated logic, programmable logic, microcode, etc.), software (e.g., instructions run on a processor to perform hardware simulation), or a combination thereof. The processing logic is configured to dynamically determine which travel properties, from a group of potential competitors, to include in a competitor set, based on a set of pricing rule conditions. In one embodiment, method 600 may be performed by pricing rules engine 117, as shown in FIGS. 1 and 4.

Referring to FIG. 6, at block 610, method 600 identifies a plurality of potential competitors for a travel property. The potential competitors may include other travel properties that share similar attributes, such as location, size, rating, etc. In one embodiment, the potential competitors may include those travel properties listed as competitors by a third party service, such as Smith Travel Research, Inc.

At block 620, method 600 identifies one or more rule conditions. The rule conditions 452 may include factors that affect which travel properties are included in a given competitor set. These factors can include, for example, a day of the week, a season of the year, a travel property rate code, a travel property room time, or other factors. Depending on a certain combination of these factors, different competitors may be most relevant to the target travel property. In one embodiment, competitor set module 410 receives a set of one or more rule conditions as input from a user. In another embodiment, the rule conditions are predefined by the system and/or exist as a default set of conditions.

At block 630, method 600 performs a pricing correlation on the plurality of potential competitors according to the one or more rule conditions. In one embodiment, to perform the pricing correlation, competitor set module 410 may compare the listed prices for each of the potential competitors to the prices of the target travel property according to the rule conditions 452. For example, if the rule conditions 452 specify a standard room on a Saturday during the summer, competitor set module 410 may determine the prices charged by each of the potential competitors under those conditions and determine which are most comparable to the price of the target travel property.

At block 640, method 600 determines, based on a result of the pricing correlation, at least one of the plurality of potential competitors to be included in a competitor set. In one embodiment, competitor set module 410 may include a set number of competitors in the competitor set 456 (e.g., the top 5, or the top 10%). In another embodiment, competitor set module 410 may include any competitor that is within a certain threshold difference from the price of the target travel property (e.g., +/−$25 or +/−% 15). The number of competitors in a competitor set or the thresholds for including competitors in the competitor set may be default values or may be adjustable by the user.

At block 650, method 600 alters the one or more rule conditions. In one embodiment, in response to input from the user, competitor set module 410 changes the rule conditions 452. For example, the user may change one or more of a day of the week, a season of the year, a travel property rate code, a travel property room time, or other factor.

At block 660, method 600 dynamically updates the competitor set to include potential competitors based on the altered rule conditions. In response to the change in rule conditions, competitor set module 410 may either dynamically update the competitor set to include competitors based on the altered rule conditions or create a new competitor set. The new or altered competitor set may include the same or different competitors depending on the result of a pricing correlation using the altered rule conditions.

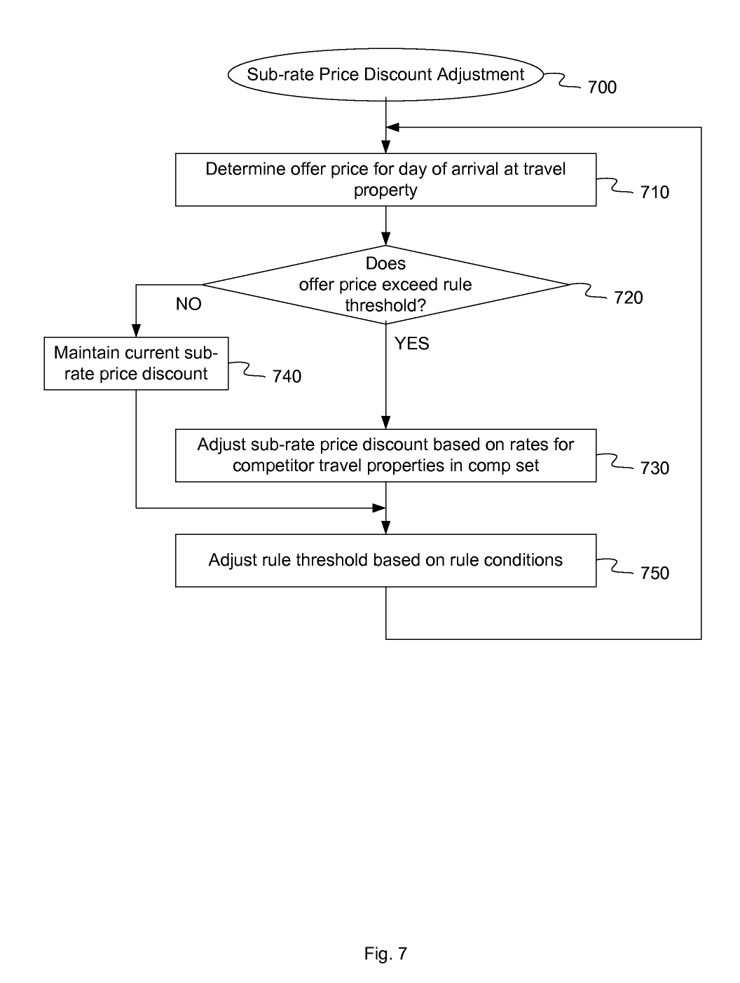

FIG. 7 is a flow diagram illustrating a dynamic sub-rate price discount adjustment method, according to an embodiment of the present invention. The method 700 may be performed by processing logic that comprises hardware (e.g., circuitry, dedicated logic, programmable logic, microcode, etc.), software (e.g., instructions run on a processor to perform hardware simulation), or a combination thereof. The processing logic is configured to dynamically adjust a sub-rate price discount for a travel property based on a set of pricing rule conditions. In one embodiment, method 700 may be performed by pricing rules engine 117, as shown in FIGS. 1 and 4.

Referring to FIG. 7, at block 710, method 700 determines an offer price for a booking at a travel property. The offer price may be based on a capacity of the travel property and a forecasted demand for bookings at the travel property. In one embodiment, sub-rate module 415 determines an offer price for a booking at the target travel property. The offer price may be obtained from one of travel sessionizer 114 or profit optimization module 116. In another embodiment, the offer price may be input by a user of pricing rules engine 117.

At block 720, method 700 compares the offer price to a rule threshold and determines whether the offer price exceeds the rule threshold. Sub-rate module 415 may compare the offer price to a rule threshold 454. The rule threshold may be a price point at which a given pricing rule takes effect. Since the offer price is based on demand, as the compression at a travel property increases (i.e., as the travel property approaches its maximum capacity), the offer price will normally increase as well. In one embodiment, the rule threshold may be defined according to other factors, such as bookings at the property or the forecasted demand for the day of arrival. Thus, in one embodiment, once the offer price increases above a given threshold, a travel property may reduce the sub-rate price discounts accordingly. In one embodiment, rather than closing out a particular sub-rate (i.e., not offering any rooms in the associated category), sub-rate module 415 may reduce the corresponding sub-rate discount to a lower amount, or potential to zero. Thus, rooms at that sub-rate may still be available, even if the sub-rate price is close to or equal to the standard rate. In another embodiment, method 700 may determine whether the offer price drops below a rule threshold.

If the offer price exceeds the rule threshold, at block 730, method 700 adjusts a sub-rate price discount for the travel property according to rates charged by competitor travel properties in an identified competitor set. In one embodiment, sub-rate module 415 adjusts the sub-rate price discounts 458 according to rates charged by competitor travel properties in the identified competitor set. As discussed above, the competitor set may take into account certain rule conditions 452. Similarly, the rule threshold 454 may be specific to a set of rule conditions. For example, the rule threshold 454 may be set to a first value for weekdays and to a second value for weekends. In other embodiments, some other combination of one or more rule conditions 452 may be used. In one embodiment, a sub-rate discount rule enforced by sub-rate module 415 may specify that when the rule threshold is met 454, the sub-rate price discount should be set based on rates from the competitor set. For example, the sub-rate price discount may be set in order to match a representative (e.g., average, highest, lowest) price from the competitor set 456. In another embodiment, the sub-rate price discount may be set to be a certain amount higher or lower than the representative price. In one embodiment, sub-rate module 415 adjusts the sub-rate price discounts 458 according to rates charged by the same hotel for different segments. For example, the sub-rate price discount for one segment may be set in order to match the price of another segment, to be a certain amount higher or lower than another segment or to have an offset from another segment that is equal to the offset between other segments. If the offer price does not exceed the rule threshold, at block 740, method 700 maintains a current sub-rate price discount.

At block 750, method 700 adjusts the rule threshold based on one or more rule conditions. The sub-rate price discount rule may be configured by the user to include any adjustment to the sub-rate price discount based on the competitor set. Sub-rate module 415 may enforce different rules, using different rule thresholds 454, and different sub-rate price discounts 458, for any set of rule conditions 452. Method 700 returns to block 710 and repeats the operations at blocks 710-730 based on the adjusted rule threshold. In one embodiment, a pricing rule may end when the property reaches a certain percentage of capacity or some number of days prior to the day of arrival.

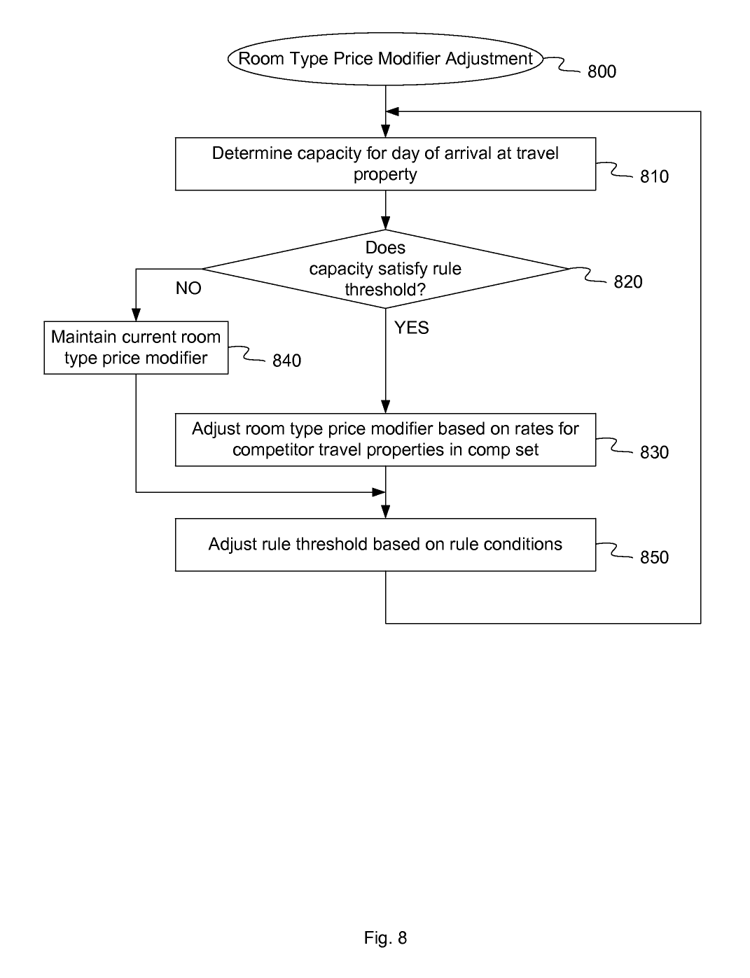

FIG. 8 is a flow diagram illustrating a dynamic room type price modifier adjustment method, according to an embodiment of the present invention. The method 800 may be performed by processing logic that comprises hardware (e.g., circuitry, dedicated logic, programmable logic, microcode, etc.), software (e.g., instructions run on a processor to perform hardware simulation), or a combination thereof. The processing logic is configured to dynamically adjust a room type price modifier for a travel property based on a set of pricing rule conditions. In one embodiment, method 800 may be performed by pricing rules engine 117, as shown in FIGS. 1 and 4.

Referring to FIG. 8, at block 810, method 800 determines a capacity of the travel property for a given room type. In one embodiment, room type module 420 determines an available capacity of a given room type at a travel property. The capacity may be obtained from one of travel sessionizer 114 or profit optimization module 116. In another embodiment, the capacity may be input by a user of pricing rules engine 117. In one embodiment, the available capacity represents the number of unsold rooms of a particular room type on a given day at the travel property.

At block 820, method 800 compares the capacity for the given room type to a rule threshold and determines whether the capacity satisfies the rule threshold. Room type module 420 may compare the capacity to a rule threshold 454. The rule threshold may be a capacity at which a given pricing rule takes effect. In one embodiment, the rule threshold may be defined according to other factors, such as bookings at the property or the forecasted demand for the day of arrival. In one embodiment, once the capacity decreases below a given threshold, a travel property may adjust the room type price modifier 459, accordingly. In one embodiment, room type module 420 adjusts the room type price modifier 459 according to rates charged by competitor travel properties in the identified competitor set. As discussed above, the competitor set may take into account certain rule conditions 452. Similarly, the rule threshold 454 may be specific to a set of rule conditions. For example, the rule threshold 454 may be set to a first value for weekdays and to a second value for weekends. In other embodiments, some other combination of one or more rule conditions 452 may be used. In another embodiment, method 800 may determine whether the capacity increases above a rule threshold.

If the capacity satisfies the rule threshold, at block 830, method 800 adjusts a price modifier for the given room type according to rates charged by competitor travel properties in an identified competitor set. In one embodiment, a room type modifier rule enforced by room type module 420 may specify that when the rule threshold is met 454, the room type price modifier should be set based on rates from the competitor set. For example, the room type price modifier may be set in order to match a representative (e.g., average, highest, lowest) price from the competitor set 456. In another embodiment, the room type price modifier may be set to be a certain amount higher or lower than the representative price. In one embodiment, room type module 420 adjusts the room type price modifiers 459 according to rates charged by the same hotel for different segments. For example, the room type price modifier for one segment may be set in order to match the price of another segment, to be a certain amount higher or lower than another segment or to have an offset from another segment that is equal to the offset between other segments. If the capacity does not satisfy the rule threshold, at block 840, method 800 maintains a current room type price modifier.

At block 850, method 800 adjusts the rule threshold based on one or more rule conditions. The room type price rule may be configured by the user to include any adjustment to the room type price modifier based on the competitor set. Room type module 420 may enforce different rules, using different rule thresholds 454, and different room type price modifiers 459, for any set of rule conditions 452. Method 800 returns to block 810 and repeats the operations at blocks 810-830 based on the adjusted rule threshold. In one embodiment, a pricing rule may end when the property reaches a certain percentage of capacity or some number of days prior to the day of arrival.

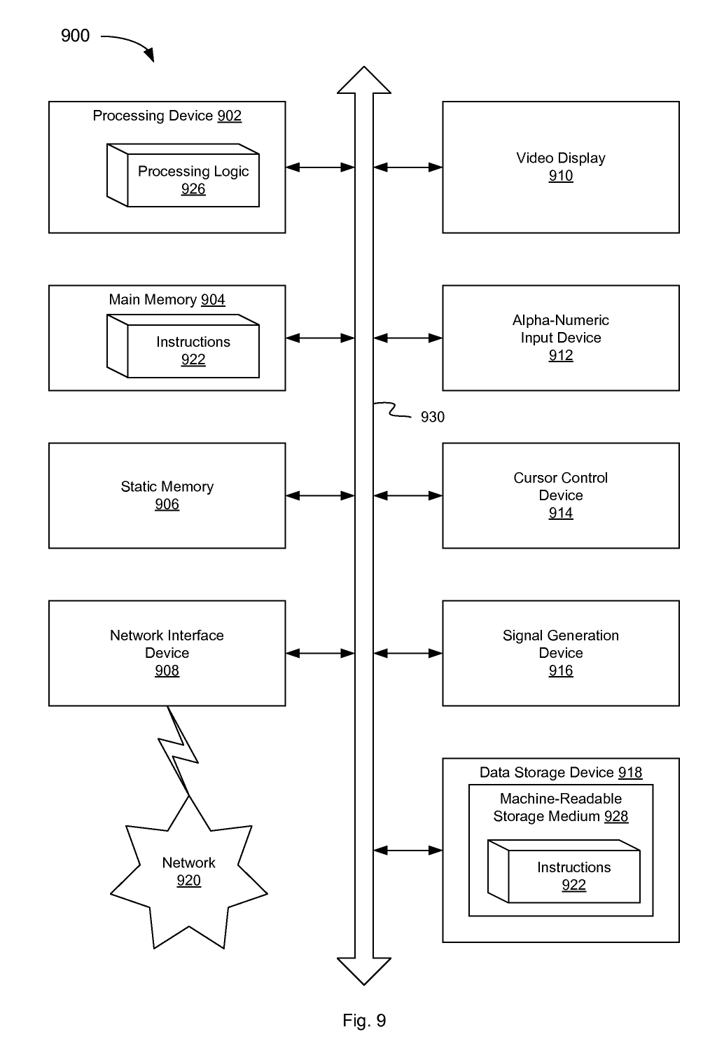

FIG. 9 illustrates a diagrammatic representation of a machine in the exemplary form of a computer system 900 within which a set of instructions, for causing the machine to perform any one or more of the methodologies discussed herein, may be executed. In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one embodiment, computer system 900 may be representative of a computing device, such as user device 120, property device 130 or a computer used to support cloud 110.

The exemplary computer system 900 includes a processing device 902, a main memory 904 (e.g., read-only memory (ROM), flash memory, dynamic random access memory (DRAM) (such as synchronous DRAM (SDRAM) or Rambus DRAM (RDRAM), etc.), a static memory 906 (e.g., flash memory, static random access memory (SRAM), etc.), and a data storage device 918, which communicate with each other via a bus 930. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Processing device 902 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 902 may also be one or more special-purpose processing devices such as an application specific integrated circuit (ASIC), a field programmable gate array (FPGA), a digital signal processor (DSP), network processor, or the like. The processing device 902 is configured to execute processing logic 926 for performing the operations and steps discussed herein.

The computer system 900 may further include a network interface device 908. The computer system 900 also may include a video display unit 910 (e.g., a liquid crystal display (LCD) or a cathode ray tube (CRT)), an alphanumeric input device 912 (e.g., a keyboard), a cursor control device 914 (e.g., a mouse), and a signal generation device 916 (e.g., a speaker).

The data storage device 918 may include a machine-accessible storage medium 928, on which is stored one or more set of instructions 922 (e.g., software) embodying any one or more of the methodologies of functions described herein. The instructions 922 may also reside, completely or at least partially, within the main memory 904 and/or within the processing device 902 during execution thereof by the computer system 900; the main memory 904 and the processing device 902 also constituting machine-accessible storage media. The instructions 922 may further be transmitted or received over a network 920 via the network interface device 908.

The machine-readable storage medium 928 may also be used to store instructions for sessionizing travel data, forecasting demand, optimizing profits at a travel property, and applying pricing rules, as described herein. While the machine-readable storage medium 928 is shown in an exemplary embodiment to be a single medium, the term “machine-readable storage medium” should be taken to include a single medium or multiple media (e.g., a centralized or distributed database, and/or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

Although the operations of the methods herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent and/or alternating manner.

1-6. (canceled)

7. A system comprising:
a processing device;
a memory operatively coupled to the processing device, the memory to store a pricing rules engine, executable by the processing device from the memory, the pricing rules engine to:
determine an offer price for a booking at a travel property, wherein the offer price is based on a capacity of the travel property and a forecasted demand for bookings at the travel property;
compare the offer price to a rule threshold; and
when the offer price exceeds the rule threshold, adjust a sub-rate price discount for a sub-rate at the travel property according to a representative rate charged by competitor travel properties in an identified competitor set, the sub-rate price discount comprising a difference between a sub-rate price and the offer price, wherein to adjust the sub-rate price discount for the travel property, the pricing rules engine is configured to reduce the sub-rate price discount in order to make the sub-rate price equal to the representative price, and maintain an availability of rooms at the travel property for the sub-rate.

8. The system of claim 7, wherein the capacity of the travel property is based on at least one of a physical number of rooms in the travel property, a number of reserved room blocks, an overbooking forecast for the travel property, or a number of prior bookings for the travel property.

9. The system of claim 7, wherein the forecasted demand for bookings is based at least in part on historical transaction data associated with the travel property and on lost business data, the lost business data comprising at least one of a regret or a denial.

10. The system of claim 7, wherein the rule threshold is adjustable based on one or more rule conditions, wherein the one or more rule conditions comprise at least one of a day of the week, a season, a travel property rate code, or a room type at the travel property.

11. The system of claim 10, wherein the competitor set comprises selected competitors based on a pricing correlation according to the one or more rule conditions.

12. The system of claim 7, wherein the sub-rate price discount comprises a reduction to a standardized rate available to a subset of customers of the travel property.

13. The system of claim 12, wherein the pricing rules engine does not close the sub-rate.

14-20. (canceled)

21. A method comprising:
determining an offer price for a booking at a travel property, wherein the offer price is based on a capacity of the travel property and a forecasted demand for bookings at the travel property;
comparing, by a processing device, the offer price to a rule threshold; and
when the offer price exceeds the rule threshold, adjusting a sub-rate price discount for a sub-rate at the travel property according to a representative rate charged by competitor travel properties in an identified competitor set, the sub-rate price discount comprising a difference between a sub-rate price and the offer price, wherein adjusting the sub-rate price discount for the travel property comprises reducing the sub-rate price discount in order to make the sub-rate price equal to the representative price, and maintaining an availability of rooms at the travel property for the sub-rate.

22. The method of claim 21, wherein the capacity of the travel property is based on at least one of a physical number of rooms in the travel property, a number of reserved room blocks, an overbooking forecast for the travel property, or a number of prior bookings for the travel property.

23. The method of claim 21, wherein the forecasted demand for bookings is based at least in part on historical transaction data associated with the travel property and on lost business data, the lost business data comprising at least one of a regret or a denial.

24. The method of claim 21, wherein the rule threshold is adjustable based on one or more rule conditions, wherein the one or more rule conditions comprise at least one of a day of the week, a season, a travel property rate code, or a room type at the travel property.

25. The method of claim 24, wherein the competitor set comprises selected competitors based on a pricing correlation according to the one or more rule conditions.

26. The method of claim 21, wherein the sub-rate price discount comprises a reduction to a standardized rate available to a subset of customers of the travel property.

27. The method of claim 26, wherein adjusting the sub-rate price discount for the travel property comprises not closing the sub-rate.

28. A non-transitory computer-readable storage medium storing instructions which, when executed, cause a processing device to perform operations comprising:
determining an offer price for a booking at a travel property, wherein the offer price is based on a capacity of the travel property and a forecasted demand for bookings at the travel property;
comparing, by the processing device, the offer price to a rule threshold; and
when the offer price exceeds the rule threshold, adjusting a sub-rate price discount for a sub-rate at the travel property according to a representative rate charged by competitor travel properties in an identified competitor set, the sub-rate price discount comprising a difference between a sub-rate price and the offer price, wherein adjusting the sub-rate price discount for the travel property comprises reducing the sub-rate price discount in order to make the sub-rate price equal to the representative price, and maintaining an availability of rooms at the travel property for the sub-rate.

29. The non-transitory computer-readable storage medium of claim 28, wherein the capacity of the travel property is based on at least one of a physical number of rooms in the travel property, a number of reserved room blocks, an overbooking forecast for the travel property, or a number of prior bookings for the travel property.

30. The non-transitory computer-readable storage medium of claim 28, wherein the forecasted demand for bookings is based at least in part on historical transaction data associated with the travel property and on lost business data, the lost business data comprising at least one of a regret or a denial.

31. The non-transitory computer-readable storage medium of claim 28, wherein the rule threshold is adjustable based on one or more rule conditions, wherein the one or more rule conditions comprise at least one of a day of the week, a season, a travel property rate code, or a room type at the travel property.

32. The non-transitory computer-readable storage medium of claim 31, wherein the competitor set comprises selected competitors based on a pricing correlation according to the one or more rule conditions.

33. The non-transitory computer-readable storage medium of claim 28, wherein the sub-rate price discount comprises a reduction to a standardized rate available to a subset of customers of the travel property, and wherein adjusting the sub-rate price discount for the travel property comprises not closing the sub-rate.
